(19) United States
(12) Patent Application Publication
(10) Pub. No.: US 2014/0369789 A1
(43) Pub. Date: Dec. 18, 2014

(54) APPARATUS HAVING ROTATABLE SKIDS AND METHODS FOR GATHERING BALES

(71) Applicant: Forage Innovations B.V., Maassluis (NL)

(72) Inventors: Curt Graham, Lynnville, IA (US); Kent Thompson, Otley, IA (US); Darin Dux, Pella, IA (US)

(21) Appl. No.: 13/918,262

(22) Filed: Jun. 14, 2013

(51) Int. Cl. A01D 90/02; A01D 90/10; A01D 87/12

(52) U.S. Cl. CPC A01D 90/02; A01D 87/127; A01D 90/10
USPC 414/24.5; 414/813

(57) ABSTRACT

Apparatus and methods that include rotatable skids for engaging the surface on which forage bales rest during bale loading.

### FIELD OF THE DISCLOSURE

The field of this disclosure relates to apparatus and methods for gathering bales and, in particular, apparatus and methods that involve rotatable skids for supporting the apparatus during bale loading.

### BACKGROUND

Crop forages such as hay (e.g., alfalfa and/or grass hay) are periodically cut in the field, dried and compacted into bales for transport and storage of the forage material. Recent evolutions in row crop production and in technology for processing these materials have led to changes in the scale and economics of harvest and to increasing potential for harvest of crop residues like corn stover. Corn stover is also baled in the field and used as livestock feed, bedding or production of biofuels. In addition, harvest technology for cotton that includes the step of baling the cotton in the field has been developed. Due to these relatively recent changes, the scale at which this type of harvest process is conducted in some instances is different than the traditional process. The density of the bales, in terms of the number of bales per acre, is higher in some instances, the labor availability is less in some instances and the criticality of timing is higher in some instances.

Materials may be baled into small square or relatively large round or square (round or square in cross-section) bales which may be tied by twine, netting or plastic wrap depending on the type of material, the type of storage and the intended use of the material. The bales are typically left in the field, near the location where the bale was formed, to minimize labor and time required for the harvest process including the baling operation.

A continuing need exists for an apparatus for gathering and transporting bales in the field after baling and that allows the bales to be gathered without accumulation of dirt or forage material on the apparatus which may dislodge in large stacks and interfere with subsequent tilling or planting operations. A need also exists for methods for gathering bales that use such apparatus.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present application is directed to an apparatus for gathering bales resting on a surface. The apparatus includes a bed for holding a bale and a loading assembly for lifting a bale and conveying it to the bed. The loading assembly includes a first arm, a second arm and a rotatable skid for supporting at least one of the first arm and second arm during bale loading. The rotatable skid has a convex surface-engaging face.

Another aspect of the present application is directed to an apparatus for gathering bales resting on a surface. The apparatus includes a bed for holding a bale. The bed has a first end and a second end and has a vertical plane that extends between the first and second ends of the bed. The apparatus includes a loading assembly for lifting a bale and conveying it to the bed. The loading assembly includes a first arm, a second arm and a rotatable skid for supporting the loading assembly during bale loading. The rotatable skid has an axis of rotation. The axis of rotation of the rotatable skid is substantially parallel to the vertical plane of the bed or the axis of rotation of the rotatable skid and the vertical plane of the bed form an angle α₁ that is less than about 45°.

A further aspect of the present disclosure is directed to an apparatus for gathering bales resting on a surface. The apparatus includes a bed mounted to a chassis for holding a bale and a loading assembly for lifting a bale and conveying it to the bed. The loading assembly includes a first arm and second arm. The loading assembly is independently pivotally attached to the chassis.

Another aspect of the present disclosure is directed to a method for gathering bales resting on a surface by use of an apparatus for gathering bales. The apparatus includes a bed mounted to a chassis for holding a bale, a rotatable skid attached to the chassis for supporting the bed during bale loading and a loading assembly for lifting a bale and conveying it to the bed. The loading assembly is pivotally connected to the chassis and includes a first arm, a second arm and a rotatable skid for supporting the first arm and/or second arm during bale loading. The apparatus is guided to a bale. The loading assembly is lowered and the rotatable skid of the loading assembly is caused to contact the surface and rotate. The loading assembly is pivoted relative to the bed. The rotatable skid attached to the chassis is contacted with the surface to cause the skid to rotate. A bale is loaded onto the bed.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of an apparatus for gathering bales;

FIG. 2 is a perspective view of a portion of the apparatus showing a hydraulic cylinder for tilting the chassis of the apparatus;

FIG. 3 is a perspective view of the apparatus prior to loading a round bale;

FIG. 4 is a perspective view of the apparatus after the round bale has been loaded onto the bed;

FIG. 5 is a perspective view of the apparatus after being loaded with bales;

FIG. 6 is a perspective view of the apparatus during unloading of bales;

FIG. 7 is a front view of the apparatus without the bed and chassis being shown;

FIG. 8 is an enlarged view of the circled area of FIG. 7 showing a rotatable skid;

FIG. 9 is an enlarged view of the circled area of FIG. 7 showing another embodiment of the rotatable skid;

FIG. 10 is a side view of an arm of the loading assembly before the apparatus is fully lowered;

FIG. 11 is a side view of an arm of the loading assembly after the apparatus is fully lowered;

FIG. 12 is a side view of an arm of the loading assembly before being fully lowered; and

FIG. 13 is a top view of the apparatus.

Corresponding reference characters indicate corresponding parts throughout the drawings.

### DETAILED DESCRIPTION

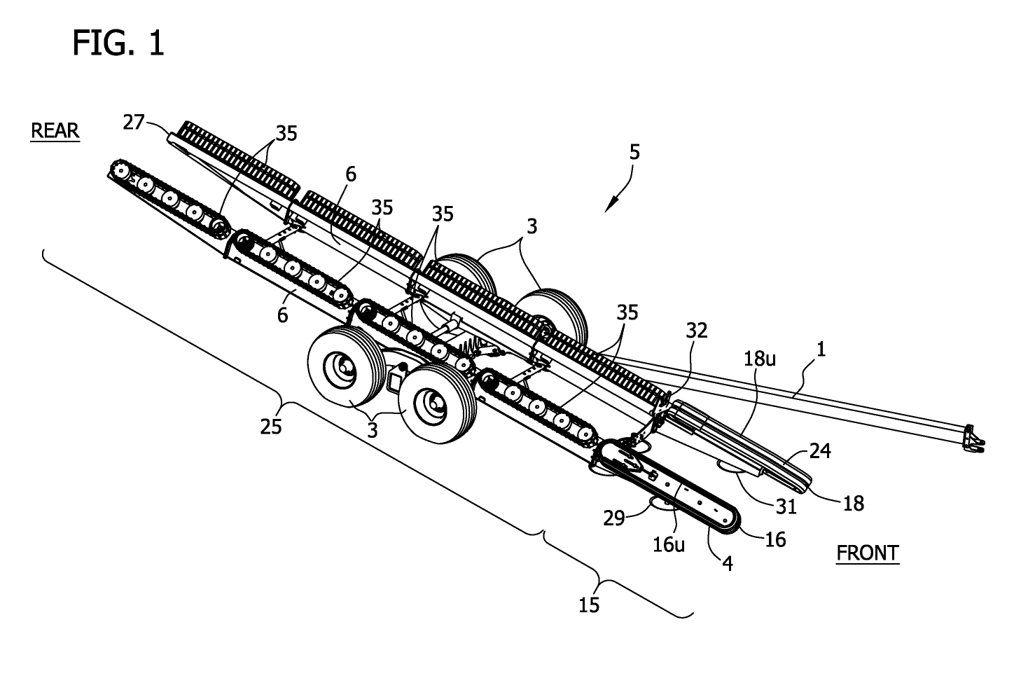

An embodiment of an apparatus for gathering bales is generally referred to as 5 in FIG. 1. The apparatus 5 includes a bed 25 for holding one or more bales and a loading assembly 15 for lifting a bale of the ground and conveying it to the bed. The apparatus 5 includes a tongue 1 for pulling the apparatus by use for example, a tractor or other pulling vehicle. In some embodiments (not shown) the apparatus 5 includes its own propulsion mechanism rather than being pulled by a pulling vehicle.

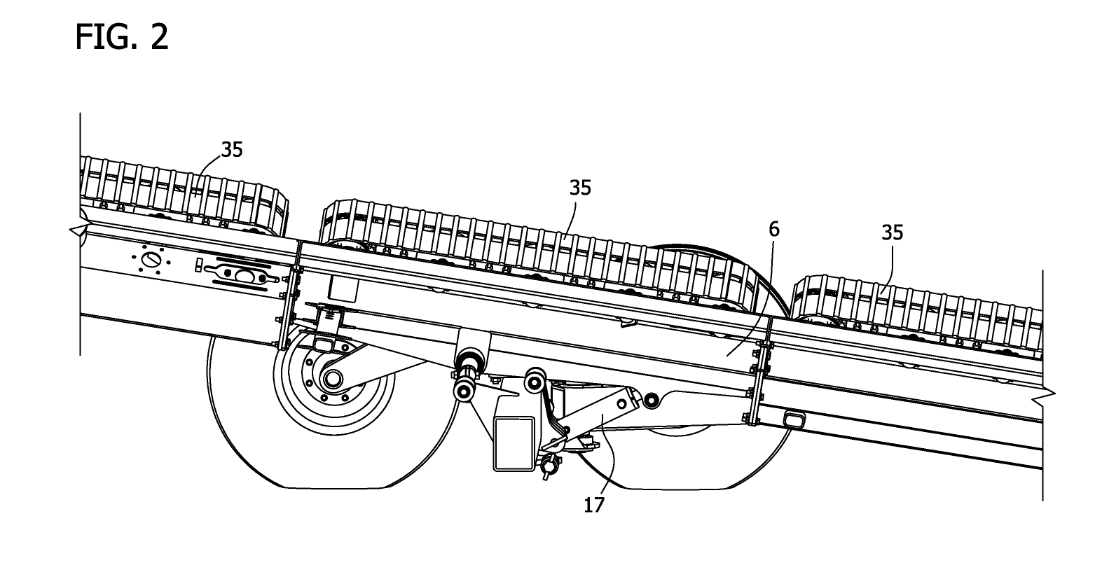

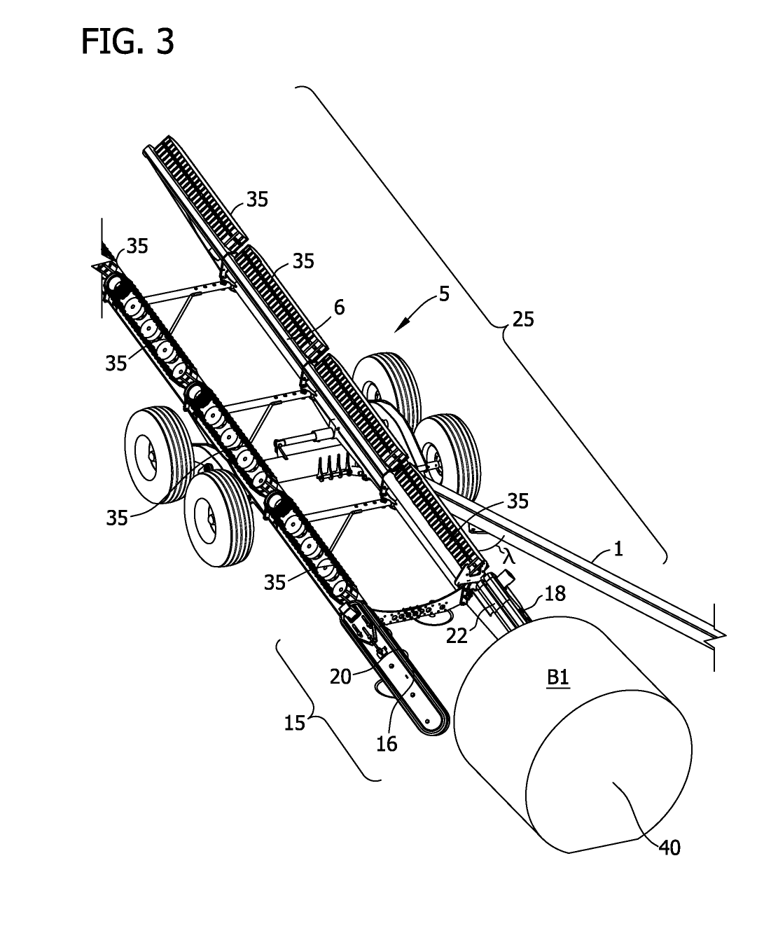

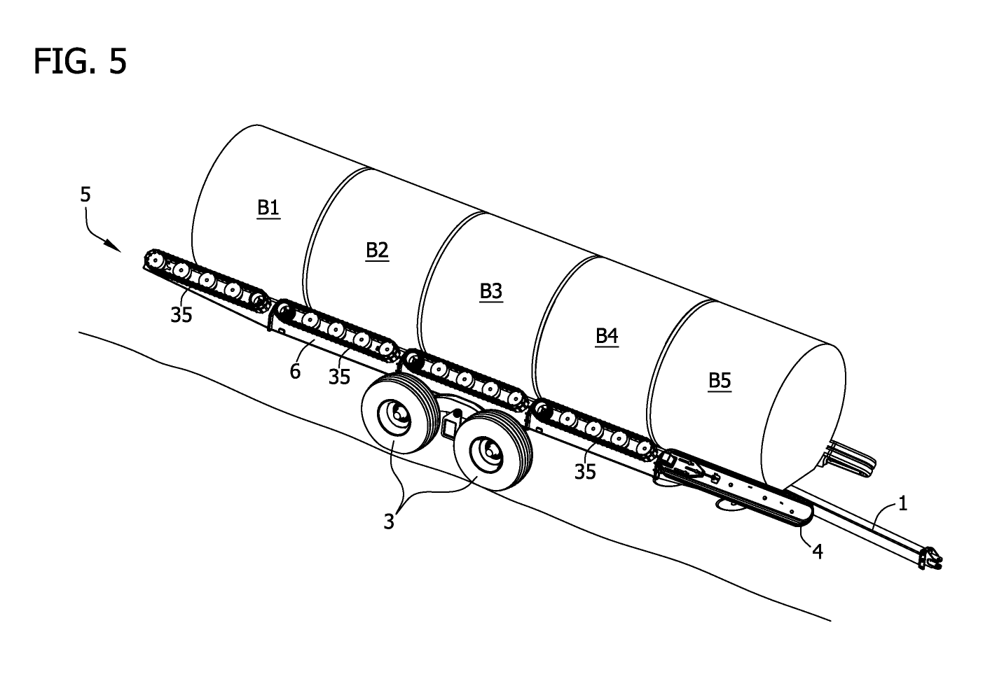

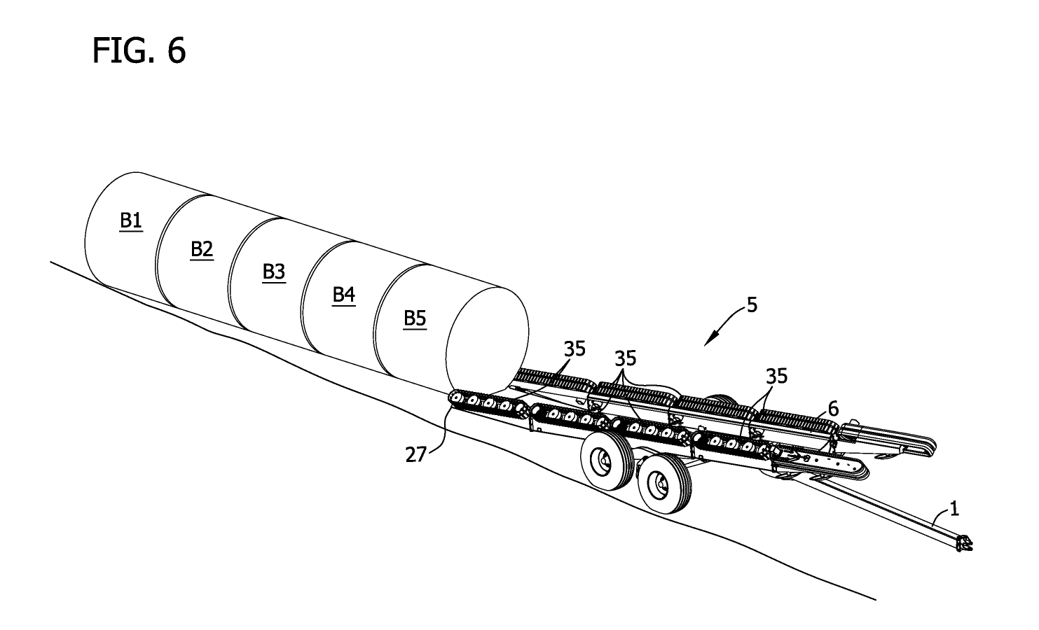

The apparatus 5 includes wheels 3. The wheels 3 on each side of the apparatus 5 are attached to a tandem axle 19 by use of hub and spindle assemblies (not shown). The tandem axles 19 are connected by a frame which is pivotally connected to the bed chassis 6. This arrangement allows the bed 25 to be tilted between various positions. The bed may be tilted to a forward position for loading the bales (FIG. 3) or for unloading to the front, to a middle position used after bales have been loaded for transportation of the loaded bales (FIG. 5) or to a rearward tilted position for unloading and re-loading of bales to the rear (FIG. 6). The apparatus 5 may be tilted hydraulically through manual or automatic control by use of a hydraulic cylinder 17 (FIG. 2) or by any other method available to those of skill in the art. Tracks (not shown) may be used as an alternative to the wheels 3.

The loading assembly 15 includes two arms 4, 24 that are the first portion of the apparatus 5 to contact the bale during loading. Each arm 4, 24 includes an endless conveyor belt 16, 18. The endless conveyor belts 16, 18 may include various drive, idler and/or support rollers (not shown) for rotating the conveyor belt. In some cases the drive roller is positioned at the front, and in some cases at the rear.

Each belt 16, 18 includes upper portions 16u, 18u (FIG. 1) that are capable of carrying the weight of a bale. The movement of the belt, around the front roller and backward along the upper portion of the belt path, has been found to be effective to lift a bale off the ground and for simultaneously causing the bale to move toward the bed 25. This lifting and transporting action occurs after the two conveyor belts contact the bale B1.

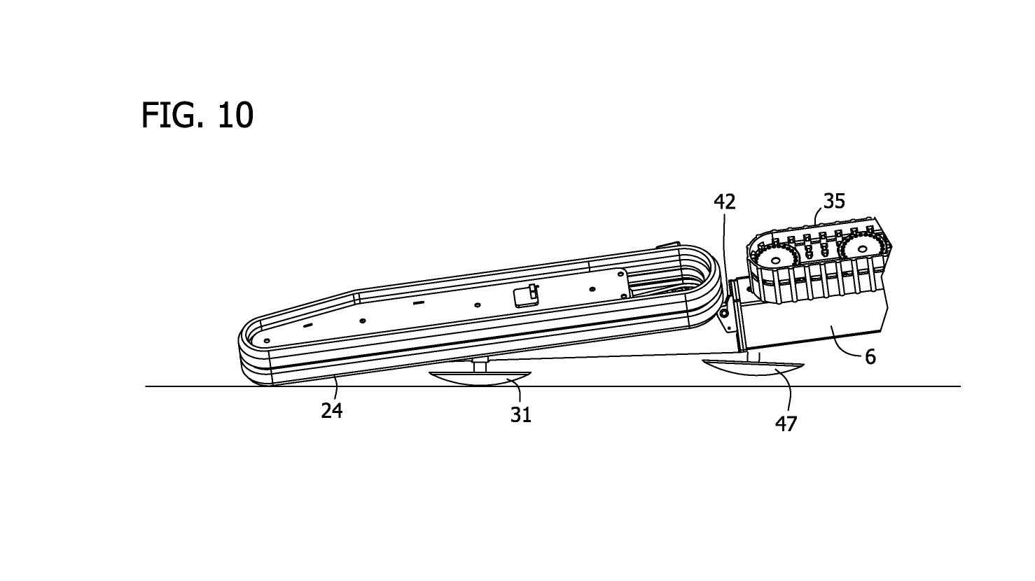

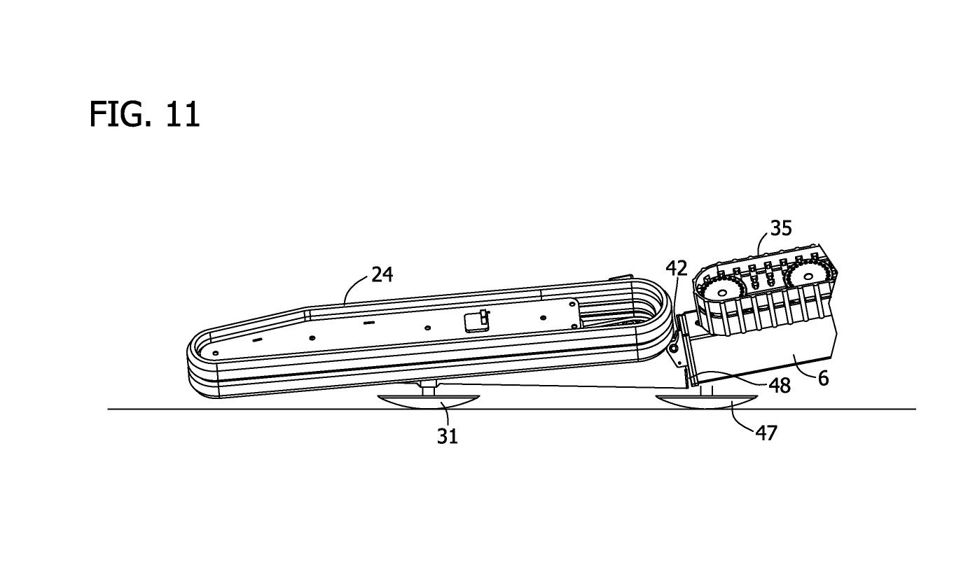

The arms 4, 24 are each independently pivotally attached to the chassis 6. The arms 4, 24 may be attached by use of a pivot pin 42 (FIGS. 10-12) or by any other suitable method which allows the arms 4, 24 to pivot relative to the chassis 6. Each side of the chassis 6 includes a stop 48 (FIG. 11) which limits the downward pivot of the arms 4, 24 relative to the chassis.

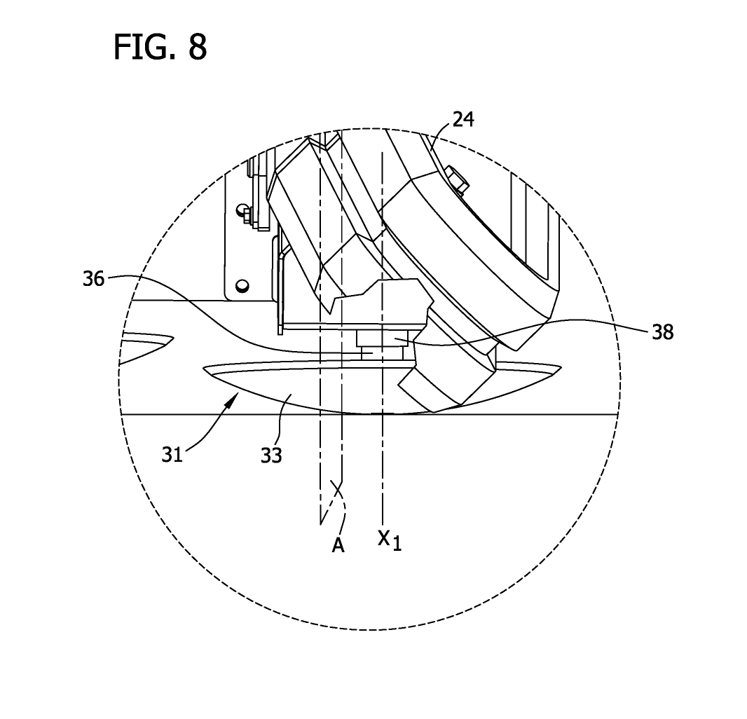

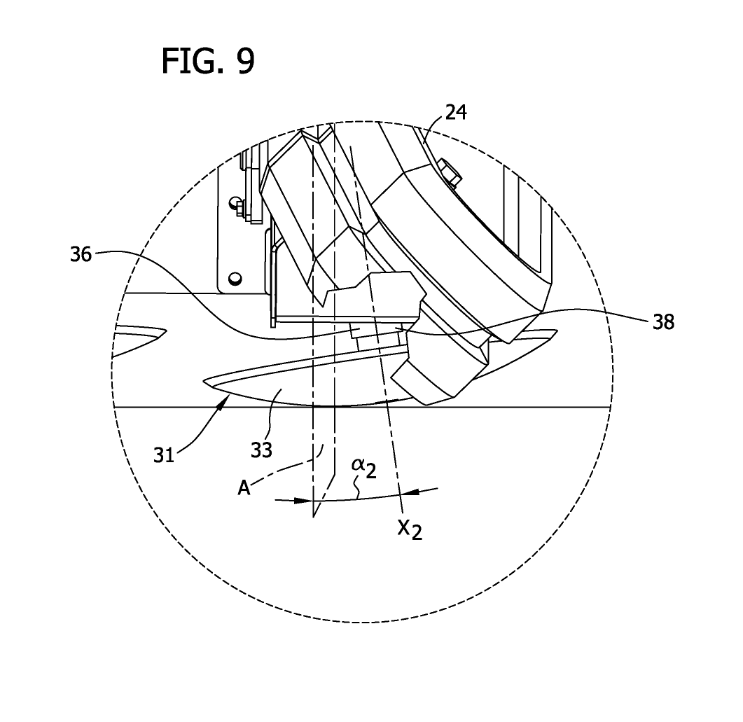

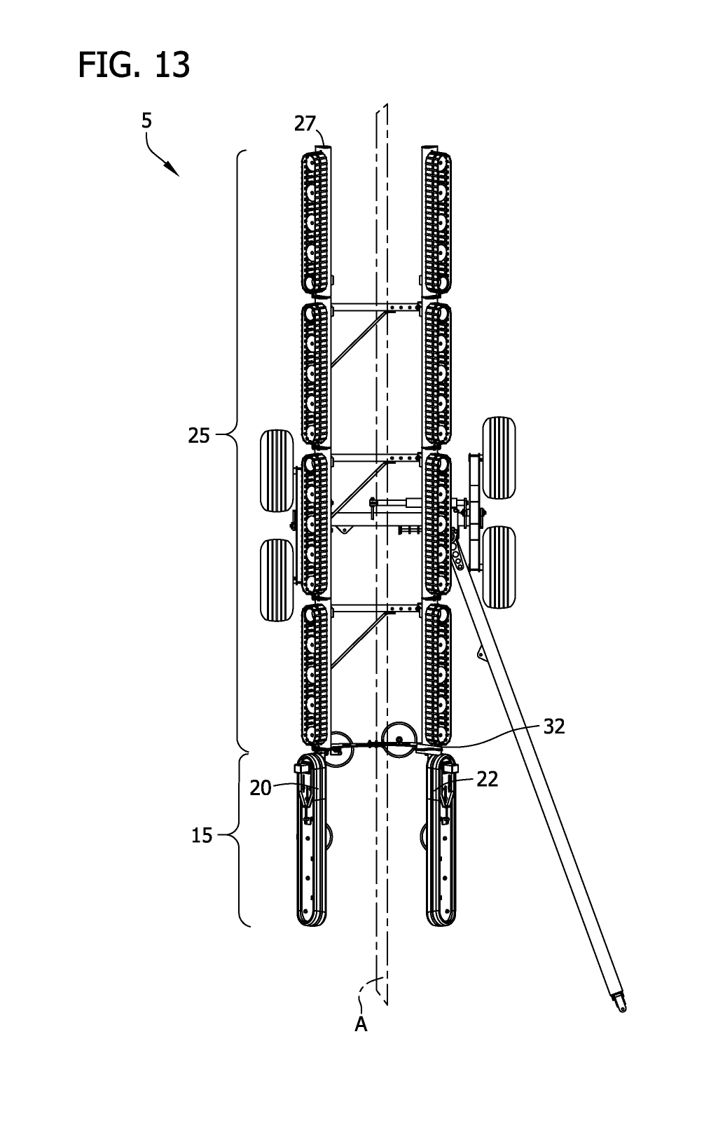

The bed 25 has a first end 32 (FIG. 1) and a second end 27 and has a lengthwise vertical plane A (FIG. 13). The vertical plane A is typically perpendicular to the surface on which the bales rest and is disposed midway along the bed 25 (and may be shown as shifted from the midway as in FIGS. 8 and 9 for illustration). The bed 25 includes a number of bed conveyors 35, each including an endless belt routed around a front idler roller and a rear powered roller that may be rotated to cause the belt to move which results in moving bales away from the loading assembly and toward the end 27 of the bed. Each conveyor 35 may have a length, the distance between the idler roller and the drive roller that is about the length of one bale. Typical bale lengths for forage products are between about forty and sixty inches, but the apparatus should not be limited by bale size; the bed could be constructed to function with bales that are in excess of sixty inches in length (e.g., cotton bales which are in the range of 100 inches in length).

Alternatively, the bed 25 may have one bed conveyor (not shown) on each side that extends from the first end 32 to the second end 27 rather than a series of bed conveyors on each side. In some embodiments, the bed 25 has a single conveyor belt (not shown) that forms a floor of the bed upon which the bales rest for moving bales toward the second end 27.

The conveyor belts 16, 18 of the first and second arms 4, 24 of the loading assembly may be driven by hydraulics, by a power-take-off system or by an electrical drive. Similarly, the bed conveyor belts 35 may be driven by hydraulics, a power-take-off system or an electric drive. The position of the loading assembly 15 and bed 25 relative to the pull vehicle (i.e., whether the apparatus is pulled directly behind the pull vehicle or at an offset position such as when bales are being gathered from the field) may be adjusted by manipulating the angle between the tongue 1 and the chassis 6 (FIG. 1) by use of hydraulics or by any other method suitable to those of skill in the art.

The bed conveyors 35 could be constructed from the same basic components used in the loading assembly conveyors, with an endless conveyor belt, an idler roller, a drive roller and supports. The embodiments illustrated herein show an alternative construction for the bed conveyors 35, each including an endless conveyor belt of a slightly different construction than the belts 16 and 18, routed around a drive pulley and an idler pulley. In some cases the drive roller of each bed conveyor 35 is positioned at the front, and in some cases at the rear.

The surface characteristics of the conveyors 16, 18 may affect the frictional engagement between the conveyor belt and the bale. The conveyor belts 16, 18 may include a surface that will adequately engage the bale to enhance the capability for the loading assembly to reliably lift the bales while also minimizing potential for damage to the bale and any bale wrapping.

It should be noted that any suitable type of conveyer belts or conveyor systems may be included in the apparatus. For instance, a conveyor belt composed of a carcass of nylon or fiberglass fibers covered by a wide variety of materials including rubber, PVC, thermoplastic polymer or the equivalent may be used. Chain conveyor systems may also be used without departing from the scope of the present disclosure. In this regard, “conveyor belt” as used herein includes any arrangement in which a belt, chain, track or the like is moved around a series of pulleys to cause movement of the belt, chain or track.

The apparatus 5 may include one or more rotatable skids (alternatively referred to as “discs”, “skid discs” or “gauge discs”) that contact the surface on which the bales rest to support one or more portions of the apparatus during bale loading. As shown in FIG. 1, the loading assembly 15 includes a first rotatable skid 29 that is attached to the first arm 4 and a second rotatable skid 31 that is attached to the second arm 24. With reference to FIG. 8 in which a rotatable skid 31 is shown in detail, each skid of the apparatus includes a convex surface-engaging face 33. The rotatable skids 29, 31 include a shaft 36 which fits within a bushing 38 for rotation of the skid 29, 31.

The rotatable skids 29, 31 each have an axis of rotation X. Referring now to FIG. 8 in which the second skid 31 is shown, the axis of rotation X₁, X₂ of the rotatable skids 29, 21 attached to the first and second arms 4, 24 may be substantially parallel to the vertical plane A (FIG. 13) of the bed 25.

In other embodiments and as shown in FIG. 9, the rotatable skids 29, 31 may be angled to promote rotation of the skids and removal of debris from the skids. The axis of rotation X of each skid 29, 31 (X₁ and X₂, respectively) may form an angle α (α₁ and α₂, respectively) with the vertical plane A of the bed 25. In some embodiments, the angles α₁, α₂ formed between the rotational axes of the first and second rotatable skids 29, 31 and the vertical plane A of the bed 25 is less than about 45° or, as in other embodiments, less than about 30°, less than about 20°, less than about 10°, from about 2° to about 30° or from about 5° to about 10°.

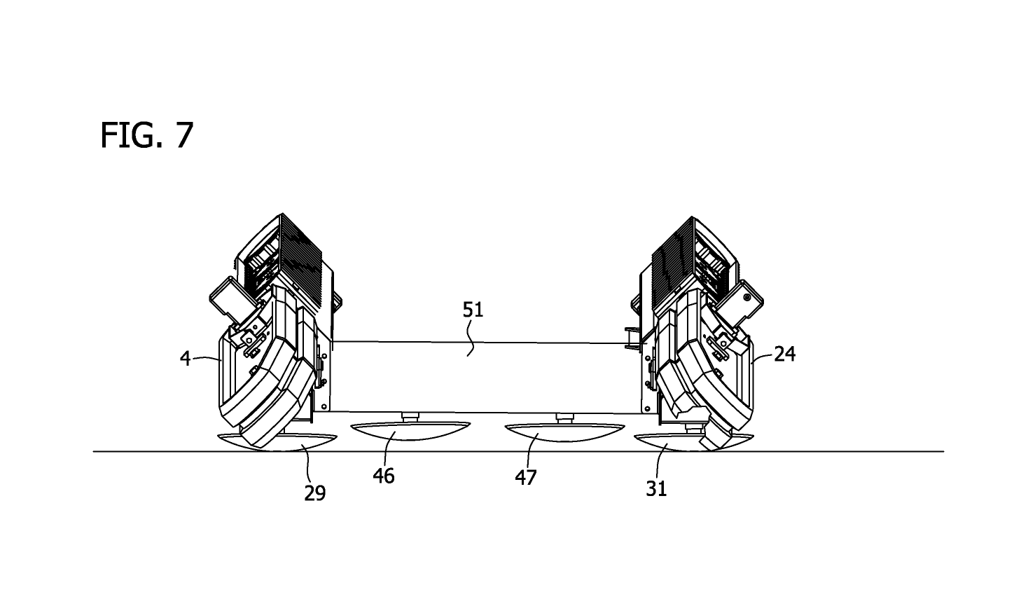

As shown in FIG. 7, each arm 4, 24 includes one rotatable skid 29, 31 attached thereto. Alternatively, the loading assembly 15 may include one rotatable skid that supports both arms 4, 24 (e.g., that supports a cross-member (not shown) connected to both arms).

During operation, the skids 29, 31 contact the surface on which the bales rest. The forward motion of the apparatus 5 causes the skids 29, 31 to rotate and dispel material that collects on the upper surface of the skids or that catches on the surface-engaging face 33 (FIG. 8) of the skids.

Referring now to FIG. 7, two rotatable skids 46, 47 having a convex surface-engaging faces are attached to a cross-member 51 of the chassis 6 (FIG. 1) which supports the bed 25. The apparatus 5 may include more or less rotatable skids attached to the chassis 6 without limitation. In some embodiments, the apparatus 5 does not include skids attached to the chassis 6. The skids 46, 47 may be substantially identical to the rotatable skids 29, 31 attached to the arms 4, 24 (e.g., may be substantially parallel to or angled relative to the vertical plane A of the bed 25).

To prepare the apparatus 5 for loading of bales, the hydraulic cylinder 17 (FIG. 2) may be actuated to tilt the first end 32 (FIG. 1) toward the surface on which the bales rest (e.g., may be tilted downward from a raised position such as the transport position shown in FIG. 5). Upon lowering the first end 32 toward the surface on which the bales rest, the rotatable skids 29, 31 attached to the loading assembly 15 contact the ground (FIG. 10) and support each arm 4, 24 of the loading assembly 15.

The hydraulic cylinder 17 (FIG. 2) may be further actuated to cause the arms 4, 24 to pivot away from the stop 48 of the chassis 6. The rearward rotatable skids 46, 47 attached to the cross-member 51 continue to lower and contact the surface on which the bales rest (FIG. 11). At this position, the arms 4, 24 may freely pivot and move upward and downward with the contour of the surface on which the bales rest (i.e., appear to “float” on the surface).

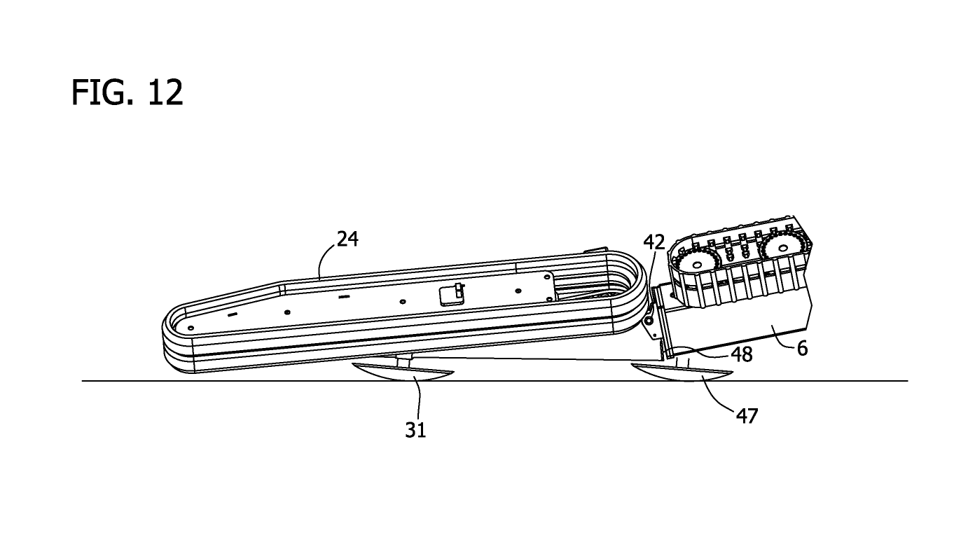

The rotatable skids 29, 31 attached to the first and second arms 4, 24 and/or the rotatable skids 46, 47 attached to the chassis 6 may be substantially vertical relative to the surface on which the bale rests when the bed is fully lowered for loading of bales as shown in FIG. 11 (one set of skids 31, 47 be shown in FIG. 11). In other embodiments and as shown in FIG. 12, the rotatable skids 29, 31, 46, 47 are tilted back during bale loading. By tilting the skids back, rotation of the skids 29, 31, 46, 47 may be promoted which allows debris to be better dispelled from the skids. In such embodiments, the axis of rotation of the rotatable skids forms an angle with the vertical axis (i.e., the axis perpendicular to the surface on which the bale rests) of less than about 30°, less than about 20°, less than about 10° or even less than about 5°.

The rotatable skids 29, 31 attached to the first and second arms 4, 24 and/or the rotatable skids 46, 47 attached to the chassis 6 may include a wear-resistant coating such as polyurethane or other wear-resistant polymer coating. The skids 29, 31, 46, 47 may be molded from such wear-resistant materials and/or from metal material (e.g., iron or steel).

In some embodiments, the rotatable skids 29, 31 attached to the first and second arms 4, 24 and/or the rotatable skids 46, 47 attached to the chassis 6 are adjustable in height and/or angle formed relative to the apparatus 5.

In operation, the apparatus 5 is pulled by the pull vehicle (not shown) in a loading position toward a bale as shown in FIG. 3. The vehicle may provide the power for running the various conveyors and positioning systems (e.g., by use of hydraulics) or the apparatus 5 may include its own dedicated power system (e.g., hydraulic system). The apparatus described herein uses a hydraulic system, but this disclosure should not be limited to a hydraulic system as the principles would apply to other power transfer technologies such as an electrical system.

Generally, the apparatus 5 is suitable for picking up cylindrical bales commonly referred to as “round” bales. Round bales are used for harvesting any material capable of being formed into a cylindrical bale such as traditional hay crops (e.g., alfalfa or grass), corn stover or other crop residues, cotton, or woody products like small diameter trees. The round bales may have a variety of sizes typically ranging from forty to one hundred inches in diameter and forty to one hundred inches in length. While the apparatus 5 is shown loading round bales in FIGS. 1-13, it should be noted that the apparatus may be adapted to pick up large square bales or even small square bales without limitation.

The apparatus 5 shown in FIGS. 1-13 is configured for loading up to 5 bales. The apparatus 5 may be modified to carry more or less bales without departing from the scope of the present disclosure.

As shown in FIG. 3, the bale B1 should be oriented such that the ends 40 of the cylindrical bale are perpendicular to the apparatus 5 as the apparatus 5 approaches the bale B1.

The chassis 6 and tongue 1 are caused to be at an angle λ relative to one another such that the loading assembly 15 and bed 25 travel outside of the path of the pull vehicle (not shown) to allow the pull vehicle to travel to the outside of bales targeted for loading.

The first and second conveyor belts 16, 18 are caused to move by rotating the drive rollers while the apparatus 5 travels toward the bale B1. As the apparatus 5 approaches the bale B, the conveyor belts 16, 18 of the arms 4, 24 contact the bale causing the bale to be lifted and simultaneously moved toward the bed 25. The bale B1 may be loaded onto the loading assembly 15 without stopping the apparatus 5 such that the apparatus 5 and the vehicle which pulls the apparatus may continually move forward during bale pick-up.

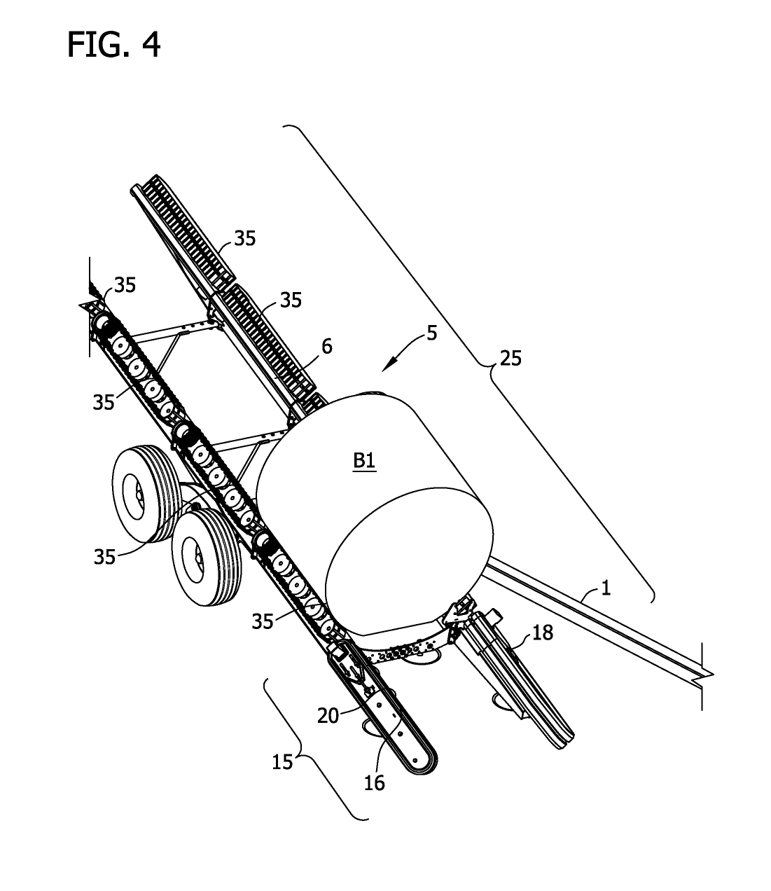

Once the bale is loaded on the loading assembly 15, belt conveyors 35 (e.g., the set of conveyors nearest the loading assembly) move to transfer the bale B1 from the loading assembly 15 to the position on the bed illustrated in FIG. 4. Once loaded onto the bed 25, the bed conveyors 35 are stopped to position the first bale adjacent the end of the loading assembly.

Once the first bale B is loaded, the apparatus 5 is directed to a second bale. The loading assembly 15 lifts the second bale and carries the second bale toward the bed 25 until it nears or contacts the first bale. Upon nearing or contacting the first bale, one or more sets of bed conveyors 35 are caused to rotate and the first and second bales travel partially down the bed 25 toward the second end 27.

Bales may continue to be loaded onto the apparatus 5 until the apparatus becomes fully loaded. Once fully loaded, the apparatus 5 may be adjusted to promote ease of travel to the unloading site. As shown in FIG. 5, the chassis 6 of the apparatus 5 may be leveled by use of hydraulic cylinder 17 (FIG. 2) and the relative position between tongue 1 and the bed 15 may be adjusted (e.g., the tongue may be adjusted to be more parallel to the bed).

As shown in FIG. 6, once the apparatus 5 is pulled to the desired unloading site for the bales, the chassis 6 is tilted by use of the hydraulic cylinder 17 (FIG. 2). The bed conveyors 35 are operated and the apparatus 5 is caused to move forward while the bales are unloaded. In some embodiments, the chassis 6 is tilted as when bales are loaded onto the bed (FIG. 3) and the apparatus is caused to move backward with rotation of the bed conveyors 35 such that bales are unloaded to the front.

Compared to conventional apparatus for gathering bales, the apparatus described above has several advantages. The apparatus include rotatable skids that support the apparatus during bale loading. The rotatable skids contact the surface on which the bales rest which causes the skids to rotate. The rotation of the skids discharges or expels dirt and forage material that may collect on the top surface or surface-engaging face of the skids. This prevents material being discharged from the skids in large stacks that may interfere with tilling and/or planting operations. The skids may automatically alternate their direction of rotation as they follow the contour of the surface on which they rest, which promotes discharge of collected material. The rotatable skids may be angled (i.e., relative to the vertical plane of the bed when viewed from the front and/or relative to the vertical axis relative to the surface on which the bales rest when fully lowered and viewed from the side), to promote rotation of the skids. The arms of the loading assembly of the apparatus may pivot which allows them to follow the contour of the surface on which the bales rest which allows the arms to be maintained at a substantially constant position relative to the bales during bale loading. The arms may pivot independently relative to each other which allows them to maintain a substantially constant position when the contour of the surface of the bales rests varies laterally across the apparatus.

As used herein, the terms “about,” “substantially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. An apparatus for gathering bales resting on a surface, the apparatus comprising:
a bed for holding a bale;
a loading assembly for lifting a bale and conveying it to the bed, the loading assembly comprising:
a first arm;
a second arm;
a rotatable skid for supporting at least one of the first arm and second arm during bale loading, the rotatable skid having a convex surface-engaging face.

2. The apparatus as set forth in claim 1 wherein the rotatable skid is attached to the first arm.

3. The apparatus as set forth in claim 2 wherein the loading assembly comprises a second rotatable skid attached to the second arm, the second rotatable skid having a convex surface-engaging face.

4. The apparatus as set forth in claim 1 wherein the bed has a first end and a second end and has a vertical plane that extends between the first and second ends of the bed, the rotatable skid having an axis of rotation, wherein (1) the axis of rotation of the rotatable skid is substantially parallel to the vertical plane of the bed or (2) the axis of rotation of the rotatable skid and the vertical plane of the bed form an angle α₁, α₁ being less than about 45°.

5. The apparatus as set forth in claim 4 wherein the rotatable skid is attached to the first arm of the loading assembly, the apparatus comprising a second rotatable skid attached to the second arm of the loading assembly, the second rotatable skid having an axis of rotation, wherein (1) the axis of rotation of the second rotatable skid is substantially parallel to the vertical plane of the bed or (2) the axis of rotation of the second rotatable skid and the vertical plane of the bed form an angle α₂, α₂ being less than about 45°.

6. The apparatus as set forth in claim 5 wherein the axis of rotation of the first rotatable skid and the axis of rotation of the second rotatable skid are substantially parallel to the vertical plane of the bed.

7. The apparatus as set forth in claim 4 wherein the axis of rotation of the first rotatable skid and the vertical plane of the bed form an angle α₁, α₁ being less than about 45° and wherein the axis of rotation of the second rotatable skid and the vertical plane of the bed form an angle α₂, α₂ being less than about 45°.

8. The apparatus as set forth in claim 4 wherein the axis of rotation of the rotatable skid is substantially parallel to the vertical plane of the bed.

9. The apparatus as set forth in claim 4 wherein the axis of rotation of the rotatable skid and the vertical plane of the bed form an angle α₁, α₁ being less than about 45°.

10. The apparatus as set forth in claim 9 wherein α₁ is less than about 30°.

11. The apparatus as set forth in claim 1 wherein the bed is mounted to a chassis and the loading assembly is pivotally attached to the chassis.

12. The apparatus as set forth in claim 11 wherein the first arm and second arm are independently pivotally attached to the chassis.

13. The apparatus as set forth in claim 12 wherein the chassis comprises a first stop to limit the downward pivot of the first arm and a second stop to limit the downward pivot of the second arm.

14. The apparatus as set forth in claim 1 wherein the bed is mounted to a chassis, the apparatus further comprising a rotatable skid attached to the chassis for supporting the bed during bale loading.

15. An apparatus for gathering bales resting on a surface, the apparatus comprising:
a bed for holding a bale, the bed having a first end and a second end and has a vertical plane that extends between the first and second ends of the bed;
a loading assembly for lifting a bale and conveying it to the bed, the loading assembly comprising:
a first arm;
a second arm;
a rotatable skid for supporting the loading assembly during bale loading and having an axis of rotation, wherein (1) the axis of rotation of the rotatable skid is substantially parallel to the vertical plane of the bed or (2) the axis of rotation of the rotatable skid and the vertical plane of the bed form an angle α₁ that is less than about 45°.

16. The apparatus as set forth in claim 15 wherein the axis of rotation of the rotatable skid is substantially parallel to the vertical plane of the bed.

17. The apparatus as set forth in claim 15 wherein the axis of rotation of the rotatable skid and the vertical plane of the bed form an angle α₁, α₁ being less than about 45°.

18. The apparatus as set forth in claim 17 wherein α₁ is less than about 30°.

19. An apparatus for gathering bales resting on a surface, the apparatus comprising:
a bed mounted to a chassis for holding a bale;
a loading assembly for lifting a bale and conveying it to the bed, the loading assembly comprising a first arm and second arm, the loading assembly being independently pivotally attached to the chassis.

20. The apparatus as set forth in claim 19 wherein the bed comprises a first stop to limit the downward pivot of the first arm and a second stop to limit the downward pivot of the second arm.

21. The apparatus as set forth in claim 19 comprising a rotatable skid attached to the loading assembly.

22. A method for gathering bales resting on a surface by use of an apparatus for gathering bales, the apparatus comprising a bed mounted to a chassis for holding a bale, a rotatable skid attached to the chassis for supporting the bed during bale loading, a loading assembly for lifting a bale and conveying it to the bed, the loading assembly being pivotally connected to the chassis and comprising a first arm, a second arm and a rotatable skid for supporting the first arm and/or second arm during bale loading, the method comprising:
guiding the apparatus to a bale;
lowering the loading assembly and causing the rotatable skid of the loading assembly to contact the surface and rotate;
pivoting the loading assembly relative the bed;
contacting the rotatable skid attached to the chassis with the surface to cause the skid to rotate; and
loading a bale onto the bed.

23. The method as set forth in claim 22 wherein a first rotatable skid is attached to the first arm and a second rotatable skid is attached to the second arm, the method comprising lowering the loading assembly and causing the first and second rotatable skids to contact the surface and rotate.

24. The method as set forth in claim 23 wherein the first arm and second arm are independently pivotally attached to the chassis, the method comprising pivoting the first arm relative to the bed and pivoting the second arm relative to the bed.
